(19) United States
(12) Patent Application Publication
(10) Pub. No.: US 2022/0377342 A1
(43) Pub. Date: Nov. 24, 2022

(54) VIDEO ENCODING AND VIDEO DECODING

(71) Applicant: British Broadcasting Corporation, London (GB)

(72) Inventors: MARIA CLAUDIA SANTAMARIA GOMEZ, LONDON (GB); SAVERIO BLASI, LONDON (GB); MARTA MRAK, LONDON (GB); EBROUL IZQUIERDO, LONDON (GB)

(21) Appl. No.: 17/770,845

(22) PCT Filed: Oct. 2, 2020
(86) PCT No.: PCT/EP2020/077745

§ 371 Date: Apr. 21, 2022

(30) Foreign Application Priority Data
Oct. 22, 2019 (GB) 1915256.0

(51) Int. Cl. H04N 19/132; H04N 19/105; H04N 19/11; H04N 19/159; H04N 19/176; H04N 19/46

(52) U.S. Cl. CPC H04N 19/132; H04N 19/105; H04N 19/11; H04N 19/159; H04N 19/176; H04N 19/46

(57) ABSTRACT

Intra-prediction modes are defined in that, predictions obtained in accordance with those modes are based on a sum of a first component dependent on a set of reference samples and a second component not dependent on the reference samples.

### FIELD

The present disclosure relates to a video codec. More specifically, it relates to intra-prediction in a video codec.

### BACKGROUND

Intra-prediction comprises performing a prediction in a block of samples in a video frame by means of using reference samples extracted from within the same frame. Such prediction can be obtained by means of different techniques, referred to as “modes” in conventional codec architectures.

A video compression standard is currently being developed, by the Joint Video Experts Team (JVET) of the Moving Picture Experts Group (MPEG) working group jointly established by the International Standards Organisation (ISO) and the International Electrotechnical Commission (IEC). This draft standard is termed Versatile Video Coding (VVC). In the context of VVC, a frame of samples is sub-divided into a plurality of blocks known as Coding Units (CU).

In the current VVC draft specifications, intra-prediction can be performed using a variety of different modes. Conventional intra-prediction modes include angular intra-prediction or prediction performed by means of well-known techniques such as Planar prediction or DC prediction. Angular prediction modes may be performed by means of one of a multitude of different modes (which depending on the CU shape may include wide angle extensions). In addition to this, several tools may be used when intra-predicting a block of samples. Cross Component Linear Model (CCLM) may be used to predict chroma samples from reconstructed luma samples of the same CU. Position Dependent intra-Prediction Combination (PDPC) may be employed to combine unfiltered boundary reference samples with predictions obtained using filtered samples. Intra Sub-Partition (ISP) which performs prediction and transform independently on smaller sub-partitions of a CU.

Further, in the latest VVC draft specifications, it is proposed to use Matrix-based Intra-Prediction (MIP) to predict a block of luma samples. MIP consists in multiplying the reference samples by fixed matrices to obtain a prediction for the current block. Such matrices were obtained based on pre-training, to make sure that meaningful predictions can be obtained. A number of different modes, corresponding to using different matrices, may be employed. The derivation of these matrices was produced by means of the training of a Neural-Network (NN) based approach where the coefficients in the network were trained using a training set formed of a variety of sequences of different content at various resolutions.

### DESCRIPTION OF DRAWINGS

FIG. 1 is a schematic diagram illustrating, in general terms, an approach to encoding in accordance with an embodiment described herein;

FIG. 2 is a schematic diagram illustrating a mathematic operation on which intra-prediction, in accordance with an embodiment, is based;

FIG. 3 is a schematic representation of a communications network in accordance with an embodiment;

FIG. 4 is a schematic representation of an emitter of the communications network of FIG. 3;

FIG. 5 is a diagram illustrating an encoder implemented on the emitter of FIG. 4;

FIG. 6 is a flow diagram of a prediction process performed at a prediction module of the encoder of FIG. 5;

FIG. 7 is a schematic representation of a receiver of the communications network of FIG. 3;

FIG. 8 is a diagram illustrating a decoder implemented on the receiver of FIG. 6; and

FIG. 9 is a flow diagram of a prediction process performed at a prediction module of the decoder of FIG. 8.

### DESCRIPTION OF EMBODIMENTS

Aspects of the present disclosure may correspond with the subject matter of the appended claims.

Neural Networks (NN) and other complex learning-based techniques can be seen as black boxes since the models learnt are generally difficult to interpret. In aspects disclosed herein, an approach is taken whereby a NN-based intra-prediction method is analysed to determine an understanding of the operation of the black box. It can be an object of this analysis to obtain a simplified and clear approach that can achieve similar results to the NN-based approach.

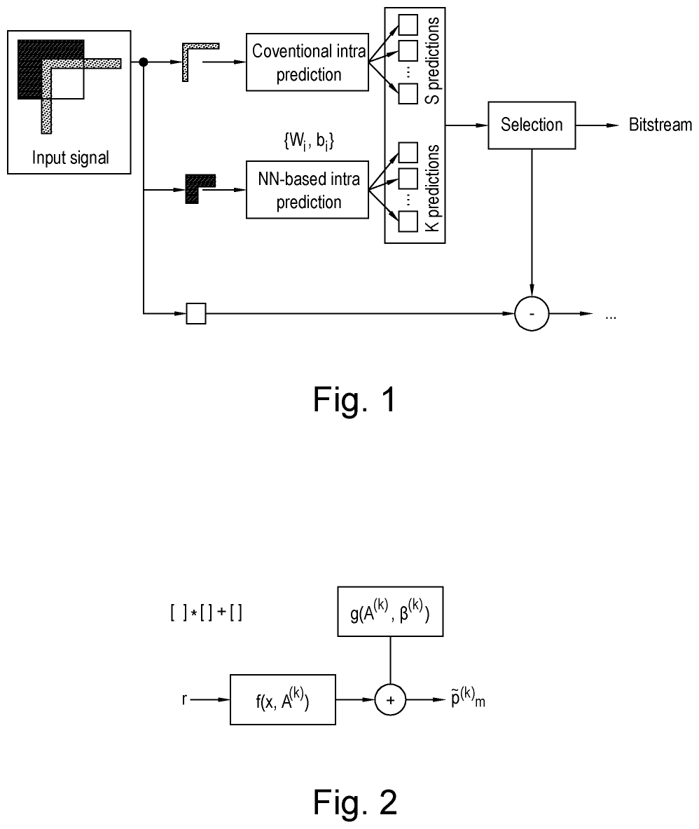

FIG. 1 illustrates, conceptually, the approach that can be taken in accordance with embodiments disclosed herein.

In particular, a prediction can be obtained by manipulating the reference samples. Different “modes” can be used to produce a prediction for a block, where each mode makes use of different parameters.

In one aspect of the present disclosure, this manipulation for a given mode consists of adding up together two components, one that depends on the reference samples, and one that does not depend on the reference samples.

A sample-wise prediction (m is the number of reference samples) can be expressed as:

$${\tilde{p}}^{( k )} = {\sum }_{i = 0}^{m - 1} {\tilde{r}}_{k} \cdot {α}^{( k )} i + {β}^{( k )}$$

where [symbol] and [symbol] are in the range [−1, 1], namely:

$${\tilde{p}}^{( k )} = \frac{{p}^{( k )}}{512} - 1$$

$$and$$

$$\tilde{r} = \frac{1}{512} \cdot r - 1$$

Thus, sample-wise prediction in the range [0,1023] can be expressed as:

$${p}^{( k )} = {\sum }_{i = 0}^{m - 1} {r}_{i} \cdot {α}^{( k )} i + 512 ( - {\sum }_{i = 0}^{m - 1} {α}^{( k )} i + {β}^{( k )} + 1 )$$

The second term, 512 (−Σᵢ₌₀^{m-1}α^{(k)}ᵢ+β^{(k)}+1), can be considered a “bias” term. In this context, if Σᵢ₌₀^{m-1}αᵢ≠1 then the “bias” term depends mostly on β. Otherwise, the “bias” term depends mostly on α.

In the above expression, k represents one possible set of parameters among a variety of possible modes, each mode identifying a possible set of parameters. The value of 512 is just an example that may depend on the bit-depth of the input signal. Other values may be used.

The above is an example of a function that could be used to predict the samples in the prediction block. In general, the prediction for a given sample may be obtained as the sum of two components as follows:

p^{(k)}=f(r,α^{(k)})+g(α^{(k)},β^{(k)})

Again, in this expression, k represents one possible set of parameters among a variety of possible modes, each mode identifying a possible set of parameters. The above represents a prediction that is computed as the sum of a component that depends on the reference samples r, and a component that does not depend on the reference samples.

FIG. 2 illustrates this mathematical operation as a data process.

As an example, the component of the prediction for each sample that depends on the reference samples may be obtained by means of defining a set of weights. A given weight is multiplied by a given reference sample; the results of these multiplications are then added together to form a first component of the prediction that does depend on the reference samples.

As an example, characteristics of the weights may be governed by the location of the sample in the prediction block. As an example, the sum of the weights may depend on the distance of each prediction sample from the reference samples. As an example, information on the location of the sample in the prediction block may be used to derive the weights.

As an example, the component of the prediction for each sample that does not depend on the reference samples may depend on various parameters. It may depend on the weights that are used to compute the first component of the prediction that does depend on the reference samples. It may also depend on a fixed parameter that is independent of the weights that are used to compute the first component of the prediction that does depend on the reference samples. It may be obtained by a combination of these two.

As another example, the component of the prediction for each sample that does not depend on the reference samples may be obtained based on the current mode being used to predict the block, or it may depend on other characteristics of the current block (such as its weight or height) and/or it may depend on characteristics of previously decoded blocks, such as their prediction modes, or their size.

As another example, the fixed parameter may be extracted from a Look-Up-Table (LUT), where various LUTs may be defined. An index may be signalled in the bitstream to refer to a specific item in the LUT. As another example, the correct element in the LUT may depend on the current mode being used to predict the block, or it may depend on other characteristics of the current block (such as its weight or height) and/or it may depend on characteristics of previously decoded blocks, such as their prediction modes, or their size.

As another example, the component of the prediction for each sample that does not depend on the reference samples may be obtained based on a learning mechanism which happens during decoding.

As another example, the component of the prediction for each sample that does not depend on the reference samples may be obtained based on parameters that are extracted from the bitstream. As an example, it may depend on the weights that are used to compute the first component of the prediction that does depend on the reference samples, where such weights may be extracted from the bitstream. It may also depend on fixed parameters that are independent of the weights that are used to compute the first component of the prediction that does depend on the reference samples, where such fixed parameters may be extracted from the bitstream. It may be obtained by a combination of these two.

As an example, the weights or the fixed parameters may be obtained based on an inference process that is performed at the decoder side. Alternatively, they may be computed based on both information that is extracted from the bitstream and based on an inference process that is performed at the decoder side.

As another example, the inference process may depend on analysing the total sum of the weights. For instance, in case the sum of the weights is equal or close to the value of 1, then the component of the prediction for each sample that does not depend on the reference samples may be obtained based only, or mostly, on the fixed parameter; or conversely, in case the sum of the weights is not close to the value of 1, then the component of the prediction for each sample that does not depend on the reference samples may be obtained based only, or mostly, on the weights.

As another example, the component of the prediction for each sample that does not depend on the reference samples may be derived by extracting the magnitude of this component from the bitstream, As another example, the component of the prediction for each sample that does not depend on the reference samples may be derived by extracting its sign, namely whether the value of the component is greater or equal than zero, from the bitstream.

The two components of the prediction, namely a component that depends on the reference samples, and a component that does not depend on the reference samples, may be used in combination or, reliance may be placed exclusively on one or other of the two components of the prediction. Each of these components may be used, together or separately, in combination with other intra-prediction methods. For instance, an angular prediction mode may be used on a block, and then the result of such prediction may be added to a component of the prediction that does not depend on the reference samples, to obtain a final prediction for the block.

The usage of any of these techniques may be signalled in the bitstream as a set of new different modes. This signalling may depend on whether a flag is present in the bitstream to indicate the usage of these new modes. This signalling may depend on whether previously decoded blocks make use of specific intra-prediction modes, to build a list of Most Probable Modes (MPM) for the current block.

Further aspects of the disclosure can be determined from the claims appended hereto.

An implementation of a communications network embodying abovementioned aspects of the disclosure will now be described.

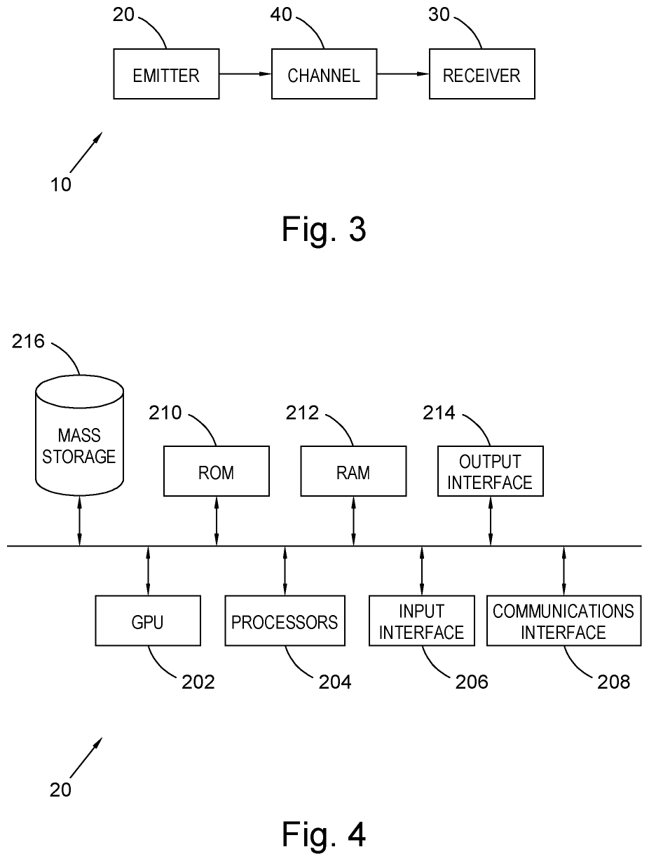

As illustrated in FIG. 3, an arrangement comprises a schematic video communication network 10, in which an emitter 20 and a receiver 30 are in communication via a communications channel 40. In practice, the communications channel 40 may comprise a satellite communications channel, a cable network, a ground-based radio broadcast network, a communications channel implemented by way of a public switched telephonic network, such as used for provision of internet services to domestic and small business premises, fibre optic communications systems, or a combination of any of the above and any other conceivable communications medium.

Furthermore, the disclosure also extends to communication, by physical transfer, of a storage medium on which is stored a machine readable record of an encoded bitstream, for passage to a suitably configured receiver capable of reading the medium and obtaining the bitstream therefrom. An example of this is the provision of a Digital Versatile Disk (DVD) or equivalent. The following description focuses on signal transmission, such as by electronic or electromagnetic signal carrier, but should not be read as excluding the aforementioned approach involving storage media.

As shown in FIG. 4, the emitter 20 is a computer apparatus, in structure and function. It may share, with general purpose computer apparatus, certain features, but some features may be implementation specific, given the specialised function for which the emitter 20 is to be put. The reader will understand which features can be of general purpose type, and which may be required to be configured specifically for use in a video emitter.

The emitter 20 thus comprises a Graphics Processing Unit (GPU) 202 configured for specific use in processing graphics and similar operations. The emitter 20 also comprises one or more other processors 204, either generally provisioned, or configured for other purposes such as mathematical operations, audio processing, managing a communications channel, and so on.

An input interface 206 provides a facility for receipt of user input actions. Such user input actions could, for instance, be caused by user interaction with a specific input unit including one or more control buttons and/or switches, a keyboard, a mouse or other pointing device, a speech recognition unit enabled to receive and process speech into control commands, a signal processor configured to receive and control processes from another device such as a tablet or smartphone, or a remote-control receiver. This list will be appreciated to be non-exhaustive and other forms of input, whether user initiated or automated, could be envisaged by the reader.

Likewise, an output interface 214 is operable to provide a facility for output of signals to a user or another device. Such output could include a display signal for driving a local Video Display Unit (VDU) or any other device.

A communications interface 208 implements a communications channel, whether broadcast or end-to-end, with one or more recipients of signals. In the context of the present embodiment, the communications interface is configured to cause emission of a signal bearing a bitstream defining a video signal, encoded by the emitter 20.

The processors 204, and specifically for the benefit of the present disclosure, the GPU 202, are operable to execute computer programs, in operation of the encoder. In doing this, recourse is made to data storage facilities provided by a mass storage device 208 which is implemented to provide large-scale data storage albeit on a relatively slow access basis, and will store, in practice, computer programs and, in the current context, video presentation data, in preparation for execution of an encoding process.

A Read Only Memory (ROM) 210 is preconfigured with executable programs designed to provide the core of the functionality of the emitter 20, and a Random Access Memory (RAM) 212 is provided for rapid access and storage of data and program instructions in the pursuit of execution of a computer program.

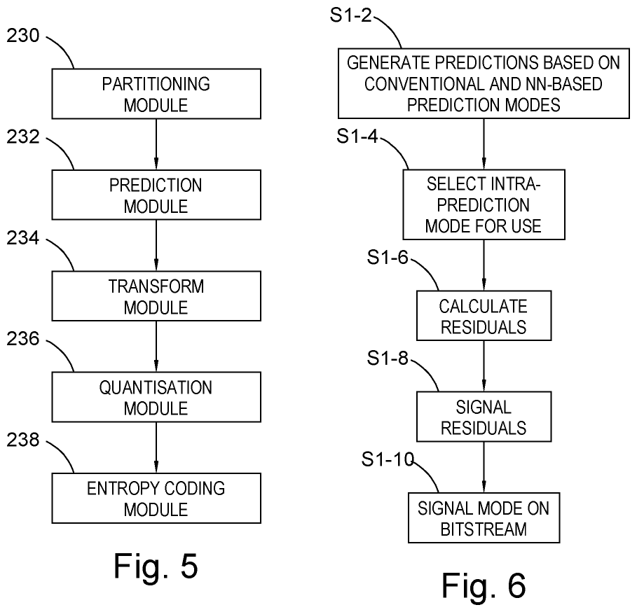

The function of the emitter 20 will now be described, with reference to FIG. 5. FIG. 5 shows a processing pipeline performed by an encoder implemented on the emitter 20 by means of executable instructions, on a datafile representing a video presentation comprising a plurality of frames for sequential display as a sequence of pictures.

The datafile may also comprise audio playback information, to accompany the video presentation, and further supplementary information such as electronic programme guide information, subtitling, or metadata to enable cataloguing of the presentation. The processing of these aspects of the datafile are not relevant to the present disclosure.

Referring to FIG. 5, the current picture or frame in a sequence of pictures is passed to a partitioning module 230 where it is partitioned into rectangular blocks of a given size for processing by the encoder. This processing may be sequential or parallel. The approach may depend on the processing capabilities of the specific implementation.

Each block is then input to a prediction module 232, which seeks to discard temporal and spatial redundancies present in the sequence and obtain a prediction signal using previously coded content. Information enabling computation of such a prediction is encoded in the bitstream. This information should be sufficient to enable computation, including the possibility of inference at the receiver of other information necessary to complete the prediction.

The prediction signal is subtracted from the original signal to obtain a residual signal. This is then input to a transform module 234, which attempts to further reduce spatial redundancies within a block by using a more suitable representation of the data. The reader will note that, in some embodiments, domain transformation may be an optional stage and may be dispensed with entirely. Employment of domain transformation, or otherwise, may be signalled in the bitstream.

The resulting signal is then typically quantised by quantisation module 236, and finally the resulting data formed of the coefficients and the information necessary to compute the prediction for the current block is input to an entropy coding module 238 makes use of statistical redundancy to represent the signal in a compact form by means of short binary codes. Again, the reader will note that entropy coding may, in some embodiments, be an optional feature and may be dispensed with altogether in certain cases. The employment of entropy coding may be signalled in the bitstream, together with information to enable decoding, such as an index to a mode of entropy coding (for example, Huffman coding) and/or a code book.

By repeated action of the encoding facility of the emitter 20, a bitstream of block information elements can be constructed for transmission to a receiver or a plurality of receivers, as the case may be. The bitstream may also bear information elements which apply across a plurality of block information elements and are thus held in bitstream syntax independent of block information elements. Examples of such information elements include configuration options, parameters applicable to a sequence of frames, and parameters relating to the video presentation as a whole.

The prediction module 232 will now be described in further detail, with reference to FIG. 6. As will be understood, this is but an example, and other approaches, within the scope of the present disclosure and the appended claims, could be contemplated.

The prediction module 232 is configured to determine, for a given block partitioned from a frame, whether intra-prediction is to be employed and, if so, which of a plurality of predetermined intra-prediction modes is to be used. The prediction module then applies the selected mode of intra-prediction, if applicable, and then determines a prediction, on the basis of which residuals can then be generated as previously noted. The prediction employed is signalled in the bitstream, for receipt and interpretation by a suitably configured decoder.

The process performed at the prediction module 232 is illustrated in FIG. 6.

FIG. 6 illustrates a method, in accordance with the described embodiment, for establishing which, of a predetermined selection of intra-prediction modes, to employ for a particular block of a frame of video data, with reference to a designated set of reference samples.

In step S1-2, candidate predictions are developed based on a library of intra-prediction modes. These intra-prediction modes include conventional intra-prediction modes, such as present in earlier video coding techniques or in earlier drafts of the VVC specification. The library also includes one or more intra-prediction modes developed as models of a NN (or other machine learning) approach to intra-prediction. That is, on the basis of training data, a NN will discern suitable intra-prediction modes and then these can be modelled as described above.

In general terms, such a mode develops an intra-prediction comprising two components, namely a component that depends on the reference samples, and a component that does not depend on the reference samples, may be used in combination or, reliance may be placed exclusively on one or other of the two components of the prediction.

Then, on the basis of a score, such as on the basis of the compression rate achievable with each mode, one of the modes is selected in step S1-4. For the selected mode, residuals are generated, comprising data which enable the reconstruction of the block from the residuals and equivalent data for a reference block.

Once the residuals have been calculated, they are signalled on the bitstream in step S1-8.

Finally, if required, the selected mode is signalled on the bitstream S1-10. It is noted that, in certain circumstances, mode selection can be implied, and need not be signalled. A variety of methods of signalling the mode have been discussed in the context of existing video coding standards and the draft VVC standards, and the precise method of signalling is not within the scope of the present disclosure.

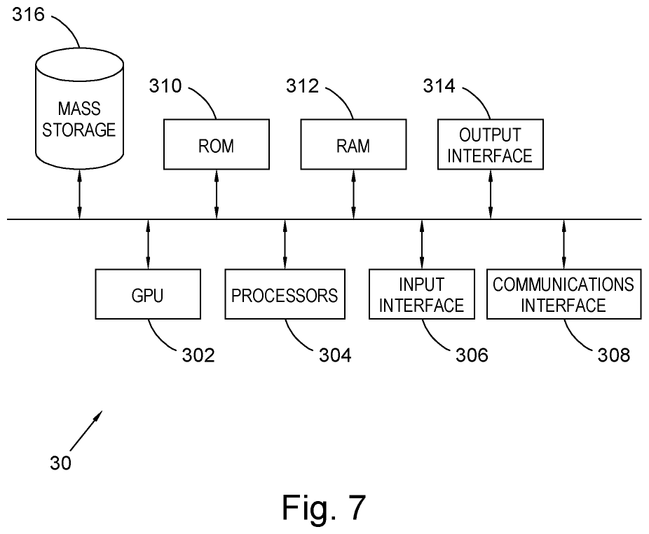

The structural architecture of the receiver is illustrated in FIG. 7. It has the elements of being a computer implemented apparatus. The receiver 30 thus comprises GPU 302 configured for specific use in processing graphics and similar operations. The receiver 30 also comprises one or more other processors 304, either generally provisioned, or configured for other purposes such as mathematical operations, audio processing, managing a communications channel, and so on.

As the reader will recognise, the receiver 30 may be implemented in the form of a set-top box, a hand held personal electronic device, a personal computer, or any other device suitable for the playback of video presentations.

An input interface 306 provides a facility for receipt of user input actions. Such user input actions could, for instance, be caused by user interaction with a specific input unit including one or more control buttons and/or switches, a keyboard, a mouse or other pointing device, a speech recognition unit enabled to receive and process speech into control commands, a signal processor configured to receive and control processes from another device such as a tablet or smartphone, or a remote-control receiver. This list will be appreciated to be non-exhaustive and other forms of input, whether user initiated or automated, could be envisaged by the reader.

Likewise, an output interface 314 is operable to provide a facility for output of signals to a user or another device. Such output could include a television signal, in suitable format, for driving a local television device.

A communications interface 308 implements a communications channel, whether broadcast or end-to-end, with one or more recipients of signals. In the context of the present embodiment, the communications interface is configured to cause emission of a signal bearing a bitstream defining a video signal, encoded by the receiver 30.

The processors 304, and specifically for the benefit of the present disclosure, the GPU 302, are operable to execute computer programs, in operation of the receiver. In doing this, recourse is made to data storage facilities provided by a mass storage device 308 which is implemented to provide large-scale data storage albeit on a relatively slow access basis, and will store, in practice, computer programs and, in the current context, video presentation data, resulting from execution of an receiving process.

A ROM 310 is preconfigured with executable programs designed to provide the core of the functionality of the receiver 30, and a RAM 312 is provided for rapid access and storage of data and program instructions in the pursuit of execution of a computer program.

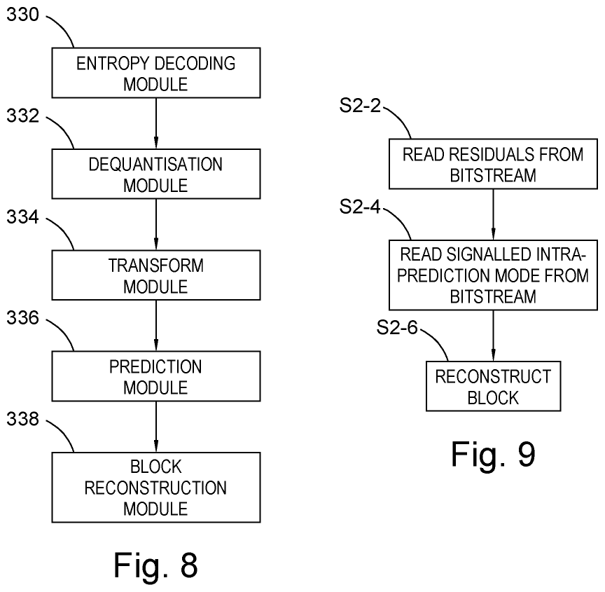

The function of the receiver 30 will now be described, with reference to FIG. 8. FIG. 8 shows a processing pipeline performed by a decoder implemented on the receiver 20 by means of executable instructions, on a bitstream received at the receiver 30 comprising structured information from which a video presentation can be derived, comprising a reconstruction of the frames encoded by the encoder functionality of the emitter 20.

The decoding process illustrated in FIG. 8 aims to reverse the process performed at the encoder. The reader will appreciate that this does not imply that the decoding process is an exact inverse of the encoding process.

A received bit stream comprises a succession of encoded information elements, each element being related to a block. A block information element is decoded in an entropy decoding module 330 to obtain a block of coefficients and the information necessary to compute the prediction for the current block. The block of coefficients is typically de-quantised in dequantisation module 332 and typically inverse transformed to the spatial domain by transform module 334.

As noted above, the reader will recognise that entropy decoding, dequantisation and inverse transformation would only need to be employed at the receiver if entropy encoding, quantisation and transformation, respectively, had been employed at the emitter.

A prediction signal is generated as before, from previously decoded samples from current or previous frames and using the information decoded from the bit stream, by prediction module 336. A reconstruction of the original picture block is then derived from the decoded residual signal and the calculated prediction block in the reconstruction block 338. The prediction module 336 is responsive to information, on the bitstream, signalling the use of intra-prediction and, if such information is present, reading from the bitstream information which enables the decoder to determine which intra-prediction mode has been employed and thus which prediction technique should be employed in reconstruction of a block information sample.

By repeated action of the decoding functionality on successively received block information elements, picture blocks can be reconstructed into frames which can then be assembled to produce a video presentation for playback.

An exemplary decoder algorithm, complementing the encoder algorithm described earlier, is illustrated in FIG. 9. In essence, the process is conventional in structure, in that, in step S2-2, the residuals are read from the bitstream, and in step S2-4 the employed intra-prediction mode is read from the bitstream. Then, in step S206, the block is reconstructed on the basis of the signalled intra-prediction mode.

What is distinctive about this approach is the nature of the available intra-prediction modes. That is, as well as (or, in some embodiments, instead of) the conventional intra-prediction modes, modes are defined in the context of models developed by machine learning.

As noted previously, the decoder functionality of the receiver 30 extracts from the bitstream a succession of block information elements, as encoded by the encoder facility of the emitter 20, defining block information and accompanying configuration information.

In general terms, the decoder avails itself of information from prior predictions, in constructing a prediction for a present block. In doing so, the decoder may combine the knowledge from inter-prediction, i.e. from a prior frame, and intra-prediction, i.e. from another block in the same frame. The present embodiment is concerned with implementation of intra-prediction and, specifically, with a particular case wherein an intra-prediction mode is implemented in accordance.

As the reader will see, on the decoder side, embodiments described herein can simplify the decoding process beyond the arrangements proposed in the current VVC draft specifications and submitted proposals for amendment thereof.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A video encoder operable to encode a block of video sample data, the block comprising a plurality of samples, with respect to a block of reference samples, the video encoder including an intra-prediction facility for encoding the block using intra-prediction, a mode selection facility operable to select, from a plurality of available pre-determined intra-prediction modes, a selected intra-prediction mode for use by the intra-prediction facility, at least one of the plurality of available predetermined intra-prediction modes being such that the intra-prediction facility, configured to operate in that mode, is operable to obtain predictions for samples in the block as a combination of a first component dependent on the reference samples, the first component being obtained in accordance with one of a set of intra-prediction modes including Planar, DC, or directional angular intra-prediction modes, and a second component not dependent on the reference samples.

2. A video encoder in accordance with claim 1 wherein the combination comprises a sum of the first component and the second component.

3. A video encoder in accordance with claim 1, wherein each intra-prediction mode has a set of parameters associated therewith, the parameters governing the first component and/or the second component of the sample predictions, wherein the parameters comprise a set of weights, the weights being employed in use as multiplicands of reference samples to produce the first component of the prediction.

4. (canceled)

5. A video encoder in accordance with claim 1, wherein each intra-prediction mode has a set of parameters associated therewith, the parameters governing the first component and/or the second component of the sample predictions, wherein the parameters comprise a fixed parameter on the basis of which the second component is produced.

6. (canceled)

7. (canceled)

8. A method of encoding a block of video sample data, the block comprising a plurality of samples, with respect to a block of reference samples, the method comprising encoding the block using intra-prediction, the method further comprising selecting, from a plurality of available pre-determined intra-prediction modes, a selected intra-prediction mode for use by the intra-prediction facility, at least one of the plurality of available predetermined intra-prediction modes being such that the encoding, using intra-prediction, obtains predictions for samples in the block as a combination of a first component dependent on the reference samples and a second component not dependent on the reference samples.

9. A video decoder operable to decode encoded video data, the decoder comprising an intra-prediction reconstruction facility operable to reconstruct, from input intra-prediction data, samples of a block of video sample data, the intra-prediction reconstruction facility being operable in one of a plurality of pre-determined intra-prediction modes, at least one of the plurality of available predetermined intra-prediction modes being such that a corresponding intra-prediction facility, configured to operate in that mode, would be operable to obtain predictions for samples in the block as a combination of a first component dependent on the reference samples, the first component being obtained in accordance with one of a set of intra-prediction modes including Planar, DC, or directional angular intra-prediction modes, and a second component not dependent on the reference samples.

10. A video decoder in accordance with claim 9, comprising a mode parser, operable to compute a most probable mode, MPM, list of most probable modes, indicative of candidates for which of the intra-prediction modes have been employed, and to decode from an input bitstream a flag indicative as to whether mode employed to encode received encoded video data is included in the MPM list, and if said flag indicates that the employed mode is included in the MPM list, to decode from an input bitstream an index to determine which mode of the MPM list has been employed, whereas if said flag indicates that the employed mode is not included in the MPM list, to decode from an input bitstream an information element to enable identification as to which of the remaining modes is to be employed in decoding the received encoded video data into a reconstructed block of video sample data.

11. (canceled)

12. A video decoder in accordance with claim 9 and operable to determine from received encoded video data an intra-prediction mode to be used to reconstruct a block of video sample data.

13. A video decoder in accordance with claim 9 and operable to receive a mode identifier on the basis of which to determine an intra-prediction mode to be used to reconstruct a block of video sample data.

14. A video decoder in accordance with claim 9 wherein the combination comprises a sum of the first component and the second component.

15. A video decoder in accordance with claim 9 wherein each intra-prediction mode has a set of parameters associated therewith, the parameters governing the first component and/or the second component of the sample predictions, wherein the parameters comprise a set of weights, the weights being employed in use as multiplicands of reference samples to produce the first component of the prediction.

16. A video decoder in accordance with claim 15 wherein the weights are further employed in use to produce the second component of the prediction.

17. A video decoder in accordance with claim 15 where the weights are determined based on the location of a predicted sample within the block, or its minimum distance from the reference sample locations.

18. A video decoder in accordance with claim 15, wherein the parameters comprise a fixed parameter on the basis of which the second component is produced.

19. A video decoder in accordance with claim 18 and comprising a mode signal detector, operable to detect on an input bitstream a characteristic of the fixed parameter including information on its magnitude or information on its sign.

20. A video decoder in accordance with claim 18 wherein the fixed parameter is determined based on the location of a predicted sample within the block, or its minimum distance from the reference sample locations.

21. A video decoder in accordance with claim 9 wherein the manner of calculation of the second component is dependent on a characteristic of the block and/or of neighbouring blocks that have been previously decoded.

22. (canceled)

23. (canceled)

24. A method of decoding encoded video data, the method comprising reconstructing, from input intra-prediction data, samples of a block of video sample data, in one of a plurality of pre-determined intra-prediction modes, at least one of the plurality of available predetermined intra-prediction modes being such that a corresponding method of intra-prediction, configured to operate in that mode, would obtain predictions for samples in the block as a combination of a first component dependent on the reference samples, the first component being obtained in accordance with one of a set of intra-prediction modes including Planar, DC, or directional angular intra-prediction modes, and a second component not dependent on the reference samples.

25. (canceled)

26. A non-transitory computer readable medium, comprising computer executable instructions, operable to configure a general purpose computer to perform a method of encoding a block of video sample data, the block comprising a plurality of samples, with respect to a block of reference samples, the method comprising encoding the block using intra-prediction, the method further comprising selecting, from a plurality of available pre-determined intra-prediction modes, a selected intra-prediction mode for use by the intra-prediction facility, at least one of the plurality of available predetermined intra-prediction modes being such that the encoding, using intra-prediction, obtains predictions for samples in the block as a combination of a first component dependent on the reference samples and a second component not dependent on the reference samples.

27. (canceled)

28. A non-transitory computer readable medium comprising computer executable instructions, operable to configure a general purpose computer to perform a method of decoding encoded video data, the method comprising reconstructing, from input intra-prediction data, samples of a block of video sample data, in one of a plurality of pre-determined intra-prediction modes, at least one of the plurality of available predetermined intra-prediction modes being such that a corresponding method of intra-prediction, configured to operate in that mode, would obtain predictions for samples in the block as a combination of a first component dependent on the reference samples, the first component being obtained in accordance with one of a set of intra-prediction modes including Planar, DC, or directional angular intra-prediction modes, and a second component not dependent on the reference samples.
